(19) United States
(12) Patent Application Publication
(10) Pub. No.: US 2005/0105705 A1
(43) Pub. Date: May 19, 2005

(54) Personalized caller identification

(75) Inventors: Albert F. Elcock, Havertown, PA (US); Thomas F. Kister, Chalfont, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/713,603

(22) Filed: Nov. 14, 2003

(51) Int. Cl. H04M 1/56; H04M 3/42; H04M 15/06

(52) U.S. Cl. 379/142.01; 379/142.15; 455/415

(57) ABSTRACT

A user creates at least one personalized caller ID (PCID) for use with a particular telephone number. The user can then use the PCID (or, if more than one is available, select from among the different PCIDs) when making a phone call. The selected PCID is transmitted for display on a called telephone when the user places the phone call. The PCID may comprise at least one of text, a photo, a video clip or a multimedia presentation. In this manner, each user of a single telephone number can have different PCID data displayed to the called party.

### FIELD OF THE INVENTION

The invention relates to telephony and, more particularly, to caller identification.

### BACKGROUND

Generally, to place a phone call, a “calling party” having a telephone and having a telephone number dials the telephone number of a “called party”, the telephone company makes the connection, and the parties can converse with one another. Caller Identification (CID) is a service provided by the telephone company which evolved from Automatic Number Identification (ANI). ANI is a method that is used by telephone companies to identify the billing account for a toll call. An early version of CID is described, for example, in U.S. Pat. No 4,582,596. Generally, CID information is transmitted on the telephone line using frequency shift keyed (FSK) modem tones, between the first and second ring. The information sent includes the date, time, and calling party's number, and often the name associated with the calling number (e.g., the owner/subscriber of the phone number). At the receiving end (called party), a modem decodes the CID information, which is displayed either on the called party's telephone or on a separate instrument. CID also available in conjunction with call waiting.

One of the problems with the current implementation of CID is that if someone other than the registered owner (subscriber) of the telephone number uses the phone to make a phone call, the CID still indicates the name of the registered owner. For example, if another person living in the same household makes the phone call, the person receiving the call (the called party) sees the CID of the registered owner, not the identification of the actual caller. This problem is especially prevalent with cellular phones, which may be shared among family members or friends.

### SUMMARY OF THE INVENTION

An object of the invention is to provide an improved technique for Caller ID (CID).

Another object of the invention is to allow a user to customize/personalize his Caller ID (CID) information when placing a call.

According to the invention, a user creates at least one personalized caller ID (PCID), and data associated with the at least one PCID is stored, e.g., on the user's telephone or on a server, database, etc. maintained by the telephone company. The user can then specify that the PCID (or, if more than one PCID is stored, select from among the stored PCIDs) be used when making a phone call. Data corresponding to the selected PCID will then be sent to the called telephone (or called telephone appliance) when the user places the phone call. The PCID data may comprise text and/or a photo or video clip. In this manner, each user of a single telephone number can have his own PCID data displayed at the called party. The PCID data may also be uploaded by the user at the beginning of placing a phone call, such as a photo taken with a cell phone. The invention allows for the following:
1. associate more than one identification with a single phone number (see FIG. 1);.
2. customize each identification associated with the single phone number (see FIGS. 2 and 3);
3. select the identification from a selection of pictures, names, etc, for each identification;
4. edit the identification;
5. select the user identification prior to placing a call;
6. send the customized user identification when the phone call is placed;
7. display the customized user identification when the phone call is received;
8. enable and disable customized user identification when a phone call is placed and/or when a phone call is received.

The invention can enhance the experience of using the phone in that text, photos, video clips, short multimedia presentations, or other data (“meta data”) can be associated with the call and subsequently transmitted and received prior to the call recipient actually answering.

The invention allows the calling party to control what the called party sees on their Caller ID, such as by allowing the called party to see who is really calling from among a number of individuals sharing usage of a single phone or phone line.

The invention is applicable to telephones (land line phones, cell phones, voice-oer-Internet (VOIP) phones, etc.), satellite caller ID modules with an enhanced display device, televisions that have a telephone interface via an internal or external module, and other telephone appliances and devices now or hereafter known. An external module for a television/telephone interface may be a set top box (STB), whole home network, or any other device that is able to answer a call and pass on the Caller ID information.

### BRIEF DESCRIPTION OF THE DRAWINGS

FIG. 1 is a diagram illustrating a configuration process for personalizing and/or customizing a caller ID (CID), according the invention;

FIG. 2 is a diagram illustrating a process of placing a phone call, according to the invention; and

FIG. 3 shows a conceptual overview of the process for personalizing/customizing a CID, according to the invention.

### DETAILED DESCRIPTION

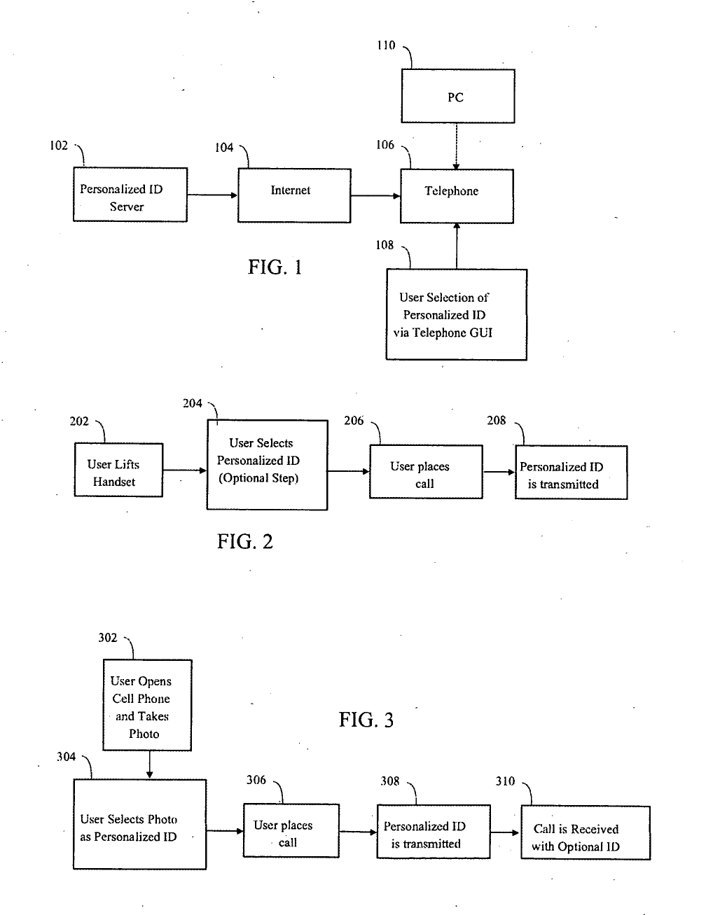

FIG. 1 is a diagram illustrating a technique for personalizing/customizing Caller ID (CID) information. In the embodiment illustrated, a user has a telephone (or telephone line, telephone connection, telephone appliance, etc., referred to herein collectively as “telephone”) 106 which may be programmed with a personalized ID. The programming may be accomplished in any number of ways. For example, a personalized ID server 102 can be provided to enable a user to personalize the telephone via a network 104, such as the Internet. One or more personalized caller identifications (PCID) may be created or edited by one or more users, and are stored either on the telephone 106 or are associated with a given telephone number and maintained by the telephone company (e.g., in a server, database, or other storage device). The ability to create/edit PCID data can be password protected. Programming of the PCID could also be provided via a graphical user interface (GUI) 108 associated with the telephone. Alternatively, the PCID data may be originated by the user from a personal computer (PC) 110. When a telephone call is placed, the user can make a selection of one of a plurality of stored PCIDs via the graphical user interface 108, which, for example, could be accessed via the telephone keypad. Alternatively, voice recognition can be provided at the telephone for selection of a user PCID.

FIG. 2 illustrates an embodiment of placing a phone call in accordance with the invention. In a first step 202, the user lifts the handset (or performs an equivalent action which initiates a telephone call) and receives a dial tone. Then, in step 204 the user selects (e.g., using a combination of keystrokes) which particular PCID should be displayed at the receiving (called) party's telephone. The choices can be presented to the user in menu form, with the user confirming his choice. Alternatively, automatic selection of a PCID could be provided via voice recognition when the user speaks into the telephone. Next, in step 206, the user places the call (e.g., by dialing the desired telephone number). Then, as indicated at step 208, data indicative of the PCID that the calling party has selected is transmitted, with the telephone call, to the receiving party. Such data can be transmitted from the calling party's telephone, or can be appended to the call by the telephone company, e.g., at a telephone central office.

It should be understood that certain of the usual CID information transmitted by the phone company (e.g., time, calling party's telephone number) can also be sent along with the user's PCID data. The invention is essentially allowing the calling party to personalize a portion of the overall information about the calling party which is sent as CID by the phone company to the called party.

FIG. 3 is a diagram illustrating a conceptual overview of an example process for a user personalizing/customizing CID. In particular, the embodiment illustrated in FIG. 3 allows a calling party to send a photograph (or video clip, short multimedia presentation, or the like) as part of the PCID. In step 302, the user takes a photo with his cell (mobile) phone. Next, at step 304, the user locally saves the photo in the telephone. Alternatively, the user could connect with the phone company and, using selected keystrokes, upload the photo for storage at the phone company as a personalized ID. This may be done in advance of or at the beginning of placing a phone call. Next, in step 306, the user places the phone call. At step 308, the photo is transmitted to the called party either directly from the caller's telephone or from the phone company, depending upon the implementation. Then, in step 310, the call is received by the called party, with the calling party's PCID data (e.g., photo).

An alternative to uploading a photo at the beginning of a phone call would be to allow the user to type in his name, or “handle”. Another alternative would be to request PCID service, then the user would speak their name into the phone. The spoken name could be transmitted as audio, or converted to text. In any case, the user has the ability to customize the caller ID information with personalized CID data.

The invention has been illustrated and described in a manner that should be considered as exemplary rather than restrictive in character. Various modifications and adaptations may be made without departing from the spirit and scope of the invention as set forth in the claims. For example, the invention should not be considered to be limited to a particular modulation scheme such as FSK, nor should it be considered to be limited to sending PCID data only between the first and second rings. Nor should it be considered to be limited to PCID data which is text and/or photos.

1. A method of personalizing caller ID (CID) information comprising:
storing data for at least one personalized CID (PCID) associated with a given telephone number;
allowing a user to select a particular PCID when placing a phone call; and
transmitting the data for the selected PCID when the user places the phone call.

2. A method according to claim 1, wherein the PCID data comprises text.

3. A method according to claim 1, wherein the PCID data comprises at least one of a photo, video clip, or multimedia presentation.

4. A method according to claim 1, wherein the PCID data is communicated by a calling telephone to a called telephone at the beginning of placing the phone call.

5. A method according to claim 1 wherein a plurality of PCIDs are associated with said given telephone number.

6. A method according to claim 1 wherein said data is stored in the user's telephone.

7. A method according to claim 1 wherein said data is stored by a telephone company.

8. A method according to claim 1 wherein said PCID provides the user's name.

9. A method according to claim 1 wherein said user places said call using the given telephone number on one of a land line telephone, cellular telephone, VoIP appliance, videophone, or television phone.

10. A method of placing a telephone call comprising:
creating at least one personalized caller ID (PCID);
associating said at least one PCID with a given telephone number;
selecting a particular PCID for a given phone call originating from the given telephone number; and
placing the phone call via the given telephone number to a called party;
wherein the selected PCID is communicated with the phone call when the phone call is placed.

11. A method according to claim 10, further comprising:
at the called party, receiving and displaying the selected PCID.

12. A method according to claim 10, wherein the PCID comprises at least one of a photo, video clip, or multimedia presentation.

13. A method according to claim 10, wherein the PCID is communicated by a calling telephone to a called telephone at the beginning of placing the phone call.

14. A telephone comprising a user interface for:
enabling a user to program a personalized caller ID (PCID); and
enabling said user to select said PCID for transmission to a called party when placing a telephone call from said telephone.

15. A telephone in accordance with claim 14, wherein said PCID comprises at least one of a text message, photo, video clip, or multimedia presentation.

16. A telephone in accordance with claim 14, wherein said PCID is stored in said telephone.

17. A telephone in accordance with claim 14, wherein said PCID is stored by a telephone company.

18. A telephone in accordance with claim 14, wherein said PCID provides the user's name.

19. A telephone in accordance with claim 14, wherein a plurality of users are able to program their own PCID for selection and transmission to a called party when placing a telephone call from said telephone.

20. A telephone in accordance with claim 14, comprising one of a land line telephone, cellular telephone, VoIP appliance, videophone, or television phone.
